(19) United States
(12) Patent Application Publication
(10) Pub. No.: US 2019/0013125 A1
(43) Pub. Date: Jan. 10, 2019

(54) SOFT MAGNETIC POWDER, METHOD FOR PRODUCING SAME, AND DUST CORE USING SOFT MAGNETIC POWDER

(71) Applicant: Panasonic Intellectual Property Management Co., Ltd., Osaka (JP)

(72) Inventors: TOSHIYUKI KOJIMA, Kyoto (JP); MASATO MAEDE, Kyoto (JP); TAKAO KUROMIYA, Osaka (JP)

(21) Appl. No.: 16/019,469

(22) Filed: Jun. 26, 2018

(30) Foreign Application Priority Data
Jul. 5, 2017 (JP) 2017-132077
Apr. 11, 2018 (JP) 2018-075899

(51) Int. Cl. H01F 1/153; H01F 27/255; C22C 45/00

(52) U.S. Cl. CPC H01F 1/15333; H01F 1/15308; H01F 1/15316; H01F 27/255; B22F 2009/048; B22F 2301/35; B22F 2301/15; B22F 2999/00; C22C 45/008

(57) ABSTRACT

Provided herein is a dust core having high mechanical strength and high magnetic permeability. An alloy powder constituting the dust core is also provided. A soft magnetic powder is used that has a plurality of protrusions of 0.1 μm or more and 5 μm or less on an alloy powder surface. A dust core is used that contains at least 80 weight % of the soft magnetic alloy powder. A method for producing a soft magnetic powder is used that includes producing an amorphous soft magnetic alloy ribbon by liquid quenching; and pulverizing the amorphous soft magnetic alloy ribbon into a powder having a thickness of 0.1 μm or more and 40 μm or less without heat treatment. The pulverization cleaves the amorphous soft magnetic alloy ribbon, and produces a protrusion on a powder surface.

### TECHNICAL FIELD

The technical field relates to a soft magnetic powder and a method for producing same, and to a dust core using the soft magnetic powder. Specifically, the present disclosure relates to a soft magnetic powder used for inductor applications such as in choke coils, reactors, and transformers, a method for producing such a soft magnetic powder, and to a dust core using the soft magnetic powder.

### BACKGROUND

The last years have seen rapid advances in the development of electrically powered automobiles, including hybrid electric vehicles (HEVs), plug-in hybrid electric vehicles (PHEVs), and electric vehicles (EVs). For improved fuel economy, there is a demand for making smaller and lighter systems for these vehicles.

The growing market for electrically powered automobiles has also created a demand for making various electronic components smaller and lighter, and there is an increasing demand for higher performance in dust cores using soft magnetic powders in applications such as in choke coils, reactors, and transformers.

For miniaturization and lightness, the materials used for dust cores require a high saturation flux density and a small core loss, and desirable DC bias characteristics.

In order to meet these demands, dust cores of desirable soft magnetic properties are proposed that use an amorphous soft magnetic alloy powder or a nanocrystalline soft magnetic alloy powder.

For example, Japanese Patent Numbers 4944971 and 6036394 describe dust cores using an amorphous soft magnetic alloy powder.

However, with a dust core produced from a pulverized alloy powder of an amorphous soft magnetic alloy ribbon as in Japanese Patent Number 4944971, it is difficult to satisfy both high mechanical strength and high magnetic permeability.

The dust core is formed by joining these powders with a binder. Because the powder has a smooth surface, it cannot be joined to the binder with a sufficient anchoring effect. Particularly, improving magnetic permeability by increasing the packing factor of the powder in the dust core reduces the amount of the binder joining the powders. This seriously impairs the mechanical strength of the dust core.

Further, because the powder has sharp edges, increasing the packing factor causes shorting as these sharp edges bite into the adjacent powders. This has prevented high packing of powders. The powder described in Japanese Patent Number 6036394 does not have sharp edges. However, because the powder surface is smooth, poor bond strength due to high packing remains a problem.

### SUMMARY

The present disclosure is intended to provide a solution to the foregoing problems of the related art, and it is an object of the present disclosure to provide a soft magnetic powder having both high mechanical strength and high magnetic permeability, a dust core using such a soft magnetic powder, and a method for producing the soft magnetic powder.

According to an aspect of the disclosure, there is provided a soft magnetic powder having a plurality of protrusions of 0.1 μm or more and 5 μm or less on an alloy powder surface.

According to another aspect of the disclosure, there is provided a dust core containing at least 80 weight % of the soft magnetic powder.

According to yet another aspect of the disclosure, there is provided a method for producing a soft magnetic powder,

the method including:

producing an amorphous soft magnetic alloy ribbon by liquid quenching; and

pulverizing the amorphous soft magnetic alloy ribbon into a powder having a thickness of 0.1 μm or more and 40 μm or less without heat treatment,

wherein the pulverization cleaves the amorphous soft magnetic alloy ribbon, and produces a protrusion on a powder surface.

The means disclosed herein enables high packing of alloy powders, and the alloy powders can join one another with sufficient strength. This has made it possible to provide an amorphous soft magnetic alloy powder or a nanocrystalline soft magnetic alloy powder having both high magnetic permeability and high mechanical strength, and a dust core using same.

### BRIEF DESCRIPTION OF THE DRAWINGS

FIG. 1 shows an electron micrograph of an alloy powder pulverized from a soft magnetic alloy ribbon of First Embodiment.

FIGS. 2A and 2B are schematic views showing the shapes of protrusions of the alloy powder of First Embodiment.

FIG. 3 shows an electron micrograph of a cross section of the alloy powder of First Embodiment.

FIG. 4 is a schematic view showing the shape of the alloy powder of First Embodiment.

FIGS. 5A to 5D are diagrams representing the steps of producing an alloy powder in First Embodiment.

### DESCRIPTION OF EMBODIMENTS

An embodiment of the present disclosure is described below with reference to the accompanying drawings.

### First Embodiment

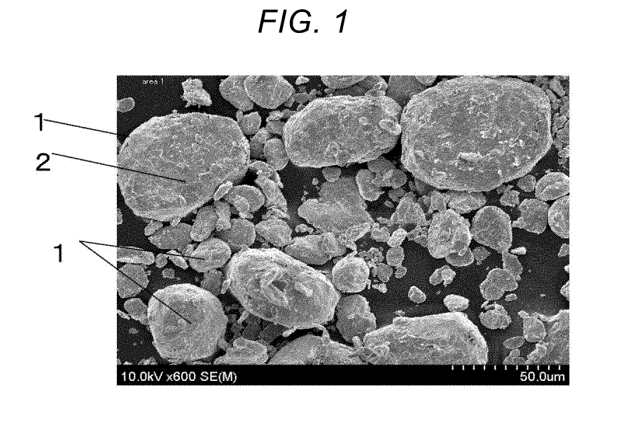

FIG. 1 shows an electron micrograph of an alloy powder of the present embodiment. The material of an alloy powder 1 is an amorphous soft magnetic alloy or a nanocrystalline soft magnetic alloy, and the alloy powder can exhibit excellent magnetic characteristics with a high saturation flux density and a small loss.

The alloy powder is a powder of, for example, an Fe-based amorphous soft magnetic alloy, an Fe-based nanocrystalline soft magnetic alloy, or a Co-based amorphous soft magnetic alloy. The amorphous soft magnetic alloy includes amorphous soft magnetic alloys that are partially nanocrystallized.

The Fe-based amorphous soft magnetic alloy, and the Fe-based nanocrystalline soft magnetic alloy may be Fe—Si—B alloys. Other examples include an Fe—Si—B-based alloy, an Fe—Cr—P-based alloy, an Fe—Zr—B-based alloy, and a Sendust-based alloy, which are alloys produced by adding additional elements such as Nb, Cu, P, and C to the Fe—Si—B alloy.

The Co-based amorphous soft magnetic alloy may be a Co—Fe—Si—B-based alloy, and an amorphous powder and a nanocrystalline powder of various known soft magnetic alloys may be used either alone or as a mixture.

Protrusion 2

As shown in FIG. 1, the surface of the alloy powder 1 has a plurality of protrusions 2. The alloy powders 1 are joined with a binder to form a dust core. The protrusions 2 strengthen the bonding between the alloy powder 1 and the binder. With the protrusions 2 of the alloy powder 1, the binder can more effectively provide an anchoring effect for bonding. This improves the mechanical strength of the dust core.

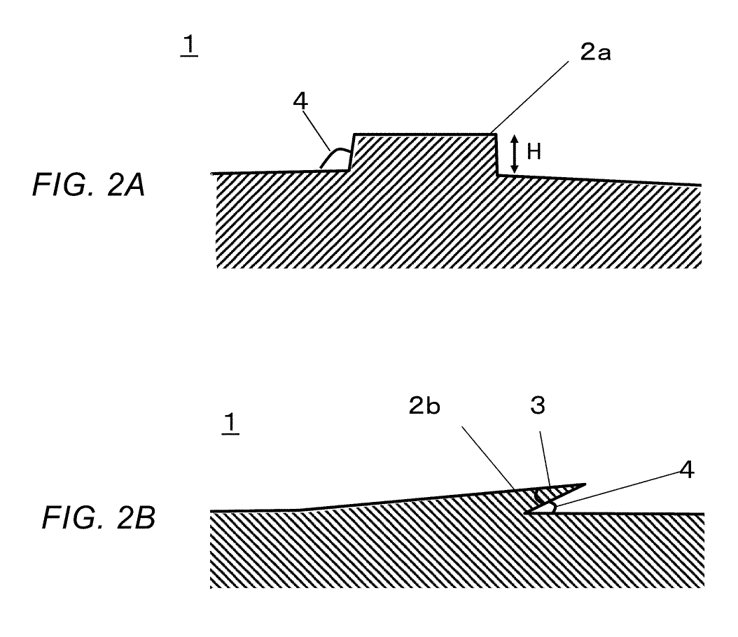

FIGS. 2A and 2B are schematic cross sectional views showing the shapes of the protrusions 2 of the alloy powder 1 of the present embodiment. Most of the protrusions 2 have the shapes shown in FIGS. 2A and 2B.

The protrusions 2 include crest-like or columnar first protrusions 2a, and second protrusions 2b that look like a rolled back skin, or that are tilted with a pointed end.

Referring to FIG. 2A, the first protrusions 2a have a height H of preferably 0.1 μm or more and 5 μm or less. First protrusions 2a with a height H of 0.1 μm or less are too small to provide a sufficient anchoring effect. First protrusions 2a with a height H of more than 5 μm are too large, and prevent the alloy powders 1 from closely contacting one another during the dust core formation. This impairs magnetic permeability. The side surface along substantially the whole perimeter of the first protrusion 2a makes an angle 4 of 90 degrees or more with the alloy powder surface. As used herein, protrusion being crest-like or columnar in shape means that the angle 4 is 90 degrees or more, and the end is not pointed.

As shown in FIG. 2B, the second protrusions 2b have an end angle 3 of preferably less than 90 degrees. With an end angle of smaller than 90 degrees, the anchoring effect for the binder improves, and stronger adhesion can be obtained.

Preferably, the angle 3 is 15 degrees or more and 60 degrees or less. With an angle 3 of 60 degree or less, a stronger anchoring effect can be obtained, and the bond strength improves. On the other hand, when the angle 3 is smaller than 15 degrees, the second protrusion 2b becomes more likely to break as it becomes thinner and weaker, with the result that the bond strength becomes weak.

The angle 4 created by the second protrusion 2b and the alloy powder surface is preferably smaller than 90°. With this angle range, the second protrusion 2b does not turn its end upward, and can prevent shorting as might occur when the second protrusion 2b pierces into the adjacent alloy powder during the dust core formation.

The height of the second protrusions 2b is about the same as the height of the first protrusions 2a. The second protrusion 2b and the first protrusion 2a look like ridges or blades. FIGS. 2A and 2B are cross sections, and the shapes of these protrusions have a depth (length).

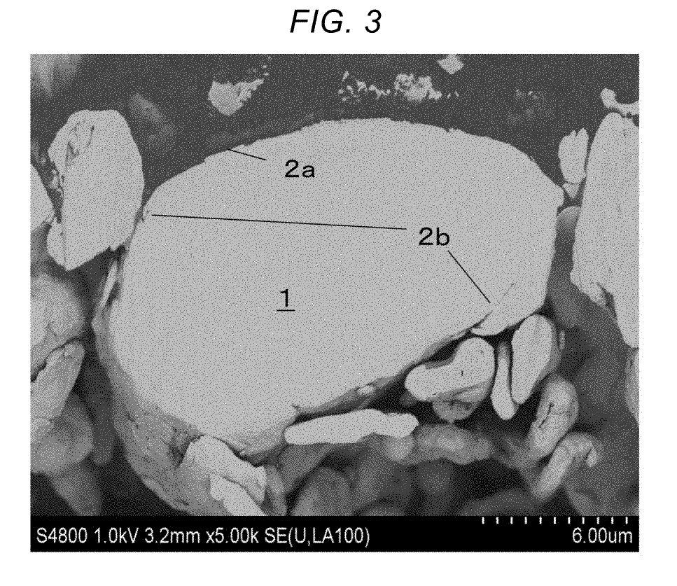

FIG. 3 shows an electron micrograph of a cross section of the alloy powder 1 of the present embodiment.

As shown in FIG. 3, the first protrusion 2a forms a raised portion. The second protrusion 2b has a shape with an end angle 3 of smaller than 90°, and creates an angle 4 of smaller than 90° with the alloy powder surface.

As shown in FIG. 1 and FIG. 3, the overall structure of the alloy powder 1 is rounded and does not have sharp angles.

Preferably, the alloy powder 1 has a roundness of 0.6 or more. With no sharp angles, the alloy powder 1 can easily be packed in high density, and the dust core can have high magnetic permeability. This makes it possible to prevent defects due to conduction of the alloy powder as might occur when the alloy powder 1 has sharp edges, and bites into the adjacent powder 1 during packing. The roundness is determined by using a Krumbein roundness chart.

The roundness is more preferably 0.75 or more. This makes high-density packing easier, and the dust core can have even higher magnetic permeability. With such a roundness, the alloy powder can easily fall in the gap between larger particles when an alloy powder of a larger particle size is used in combination for the formation of the dust core. In this way, a dust core having even higher magnetic permeability can be obtained.

The alloy powder 1 is produced by pulverizing a sheet-like ribbon. The following describes the shape of the alloy powder 1.

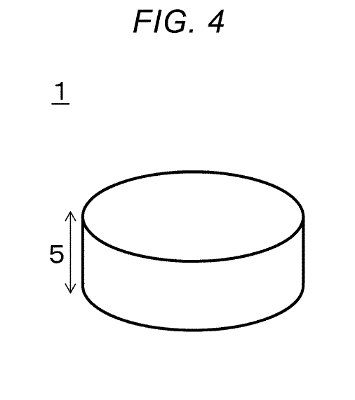

FIG. 4 is a schematic view of the alloy powder 1 of the present embodiment. As shown in FIG. 4, in its approximated elliptical column shape, the alloy powder 1 has a thickness 5 smaller than the thickness of the ribbon to be pulverized. The alloy powder 1 is produced by pulverizing a ribbon in the manner described below. The alloy powder 1 needs to be thinner than the ribbon. That is, the ribbon needs to be pulverized.

The protrusions 2 of the alloy powder 1 form as the ribbon is cleaved during the pulverization. Here, “cleave” means that the surface exfoliates in a laminar fashion during the pulverization process.

When the thickness 5 is thicker than the ribbon, it means that the ribbon is not sufficiently cleaved, and both elliptical principal surfaces of the alloy powder 1 cannot sufficiently form protrusions.

The following describes a possible mechanism in detail. The ribbon is pulverized to obtain a powder. The alloy powder 1 being thicker than the ribbon means that the surface portions of the ribbon remain at the both principal surfaces of the alloy powder 1 without being pulverized. That is, protrusions due to pulverization do not occur in the principal surface portions of the alloy powder 1.

The thickness 5 of the alloy powder 1 is preferably 0.1 μm or more and 40 μm or less. This is because the raw material ribbon cannot provide desirable magnetic properties when the ribbon thickness is more than 40 μm. When the ribbon thickness is less than 0.1 μm, the damage caused by pulverization increases, and impairs the magnetic characteristics of the alloy powder 1.

The thickness 5 is preferably 10 μm or more and 30 μm or less. Pulverization is relatively easy for a thickness of 30 μm or less, whereas a long pulverization time is required for thicknesses smaller than 10 μm. The thickness range of 10 μm or more and 30 μm or less is therefore preferred in terms of a balance between performance and productivity.

Preferably, the alloy powder 1 is nanocrystallized. Nanocrystallization can further improve magnetic permeability. It is also preferable that the alloy powder 1 be nanocrystallized to make the powder surface harder. In this way, the binder that has penetrated between the protrusions of the alloy powder 1 does not easily separate from the powder surface, and a stronger anchoring effect can be obtained for improved bond strength.

Production of Alloy Powder 1

An exemplary method of producing the alloy powder 1 of the present embodiment is described below.

(1) An amorphous soft magnetic alloy ribbon (Fe—Si—B—Cu—Nb) is produced by liquid quenching. The amorphous soft magnetic alloy ribbon (Fe—Si—B—Cu—Nb) may be produced using a single-roll or twin-roll amorphous manufacturing device. The cooling rate is, for example, about 1,000,000° C./s.

(2) The ribbon is pulverized into a powder, without heat treatment. The ribbon may be pulverized using a common pulverizer. For example, a ball mill, a stamping mill, a planetary mill, a cyclone mill, a jet mill, or a rotary mill may be used.

The ribbon is pulverized until the powder has a thickness 5 that is equal to or less than the thickness of the ribbon. This is to ensure that the ribbon is pulverized also at the surface portion so that the protrusions 2 form. It is difficult to obtain desirable magnetic characteristics when the ribbon thickness is larger than 40 μm. To avoid this, the ribbon is pulverized until the powder thickness is 40 μm or less.

The ribbon is pulverized until an average particle size of 50 μm or less, preferably 10 μm or less is achieved. This is because protrusions 2 start to occur when the average particle size reaches 50 μm or less, and can sufficiently form when the average particle size is 10 μm or less.

Details of Pulverization

The amorphous soft magnetic alloy ribbon to be pulverized is not subjected to an embrittlement process by heat treatment. With no embrittlement process, cleaving becomes more likely to occur during the pulverization. When subjected to a heat treatment for embrittlement, the ribbon increases its hardness, and pulverization becomes difficult. That is, cleaving becomes less likely to occur with embrittlement. When pulverized after an embrittlement heat treatment, the pulverized powder has a structure with sharp edges, and the alloy powder 1 cannot have a shape with a roundness of 0.6 or more.

When the alloy powder 1 has a structure with sharp edges, these sharp edges bite into the adjacent particles when packing the alloy powder 1. This causes defects due to conduction between particles of the alloy powder 1. When the amorphous soft magnetic alloy ribbon is pulverized after a heat treatment, the pulverization grinds a hard, brittle amorphous ribbon, and produces a structure having sharp edges at the crushed portions.

The following describes the extent of pulverization. The ribbon needs to be pulverized until the thickness of the alloy powder 1 (the thickness of an approximated ellipsoidal shape) becomes smaller than the thickness of the pulverized ribbon. The alloy powder 1 forms the protrusions 2 as the ribbon is cleaved as a result of pulverization. When the alloy powder 1 is thicker than the ribbon, it means that the cleaving of the ribbon is insufficient at the both ellipsoidal principal surfaces.

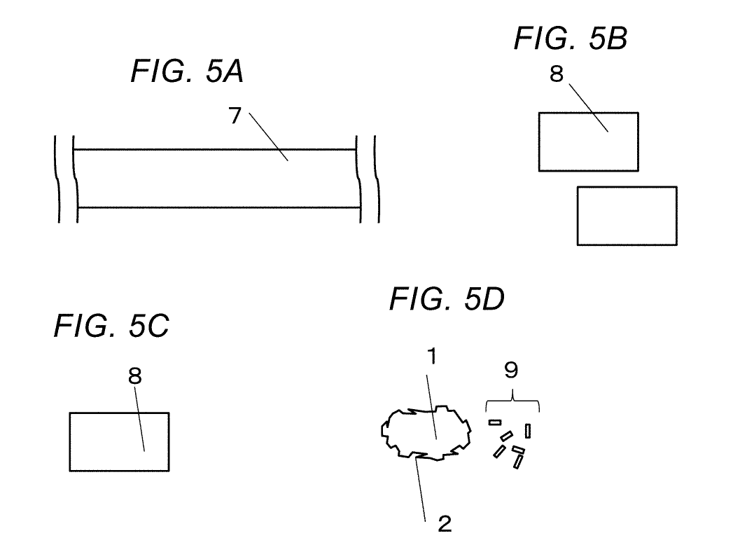

FIGS. 5A to 5D are diagrams representing the steps of forming the alloy powder 1.

In a first-pulverization step, the ribbon 7 shown in FIG. 5A is pulverized into coarsely pulverized blocks 8, as shown in FIG. 5B.

In a second-pulverization step, as shown in FIGS. 5C and 5D, the surface of the coarsely pulverized block 8 is cleaved, thereby chipping away fine powder 9, and leaving the alloy powder 1 having surface protrusions 2.

Because the protrusions 2 are formed by cleaving, the resulting protrusions 2 are a mix of protrusions that occur as small raised portions (FIG. 2A), and protrusions having a diagonally pointed end that occurs as a result of the alloy powder 1 being cut in sideways with an angle (FIG. 2B). In this way, the anchoring effect for the binder becomes even more sufficient.

As a specific example, the ribbon is pulverized with a rotary mill at 1,000 rpm to 3,000 rpm for 5 minutes to 30 minutes, and an alloy powder 1 having protrusions 2 due to surface cleaving is obtained.

(3) The amorphous soft magnetic alloy powder is nanocrystallized, as required. The alloy powder 1 obtained by pulverizing the amorphous ribbon is formed into a nanocrystalline soft magnetic alloy powder through nanocrystallization in a heat treatment conducted at a temperature that is equal to or greater than the nanocrystal precipitation temperature, and equal to or less than the temperature at which enlargement of nanocrystals occurs.

The heat treatment may be performed using a heat-treatment device, for example, such as a hot-air furnace, a hot press, a lamp, a metal sheathed heater, a ceramic heater, and a rotary kiln. The alloy powder can exhibit higher magnetic permeability with nanocrystallization, and is nanocrystallized according to the device characteristics requirements.

The alloy powder increases its surface hardness with nanocrystallization. In this way, the binder that has penetrated between the protrusions of the alloy powder does not easily separate from the powder surface, and a stronger anchoring effect can be obtained for improved bond strength.

Production of Dust Core

(1) For the production of a dust core of the present embodiment, the alloy powder 1 is mixed with a binder having desirable insulation and high heat resistance, such as a phenolic resin and a silicone resin, to produce a granulated powder.

(2) The granulated powder is charged into a mold of the desired shape having high heat resistance and molded under applied pressure to obtain a compact.

(3) The binder is cured under heat, and a heat treatment is performed at a temperature that is equal to or less than the temperature that does not cause enlargement of nanocrystals. This produces a dust core that can exhibit a high saturation flux density and desirable soft magnetic characteristics.

The dust core can have high mechanical strength and high magnetic permeability when the fraction of the pulverized alloy powder 1 in the dust core is 80 weight % or more.

The dust core of the present embodiment had a magnetic permeability that was higher than that of the related art by a factor of at least 1.3. The magnetic permeability value was 24 for the dust core of the present embodiment, and 15 to 19 for the dust core of the related art.

The dust core of the present embodiment had a mechanical strength that was higher than that of the related art by a factor of at least 1.6.

The dust core was pressurized with a press, and was measured for pressure at break.

The pressure was 30 MPa for the dust core of the present embodiment, and 14 MPa to 18 MPa for the dust core of the related art.

The present embodiment can provide a soft magnetic powder having both high mechanical strength and high magnetic permeability, and a dust core using such a soft magnetic powder.

What is claimed is:

1. A soft magnetic powder comprising a plurality of columnar first protrusions of 0.1 μm or more and 5 μm or less on an alloy powder surface.

2. The soft magnetic powder according to claim 1,
wherein the alloy powder surface has a tilted second protrusion having a pointed end, the second protrusion having an end angle of less than 90°, and creating an angle of less than 90° with the alloy powder surface.

3. The soft magnetic powder according to claim 1, wherein the alloy powder has a roundness of 0.6 or more.

4. The soft magnetic powder according to claim 1, wherein the alloy powder has a thickness of 0.1 μm or more and 40 μm or less.

5. The soft magnetic powder according to claim 1, wherein the alloy powder is an Fe-based soft magnetic powder, a nanocrystalline soft magnetic alloy powder, or a Co-based soft magnetic powder.

6. The soft magnetic powder according to claim 1, wherein the alloy powder has a nanocrystal precipitated in the alloy powder.

7. A dust core comprising at least 80 weight % of the soft magnetic powder of claim 1.

8. A method for producing a soft magnetic powder,
the method comprising:
producing a soft magnetic alloy ribbon by liquid quenching; and
pulverizing the soft magnetic alloy ribbon into a powder having a thickness of 0.1 μm or more and 40 μm or less without heat treatment,
wherein the pulverization cleaves the soft magnetic alloy ribbon and produces a protrusion on a powder surface.

9. The method of claim 8, further comprising nanocrystallizing the alloy powder by a heat treatment after the pulverization.
